(19) United States
(12) Patent Application Publication
(10) Pub. No.: US 2017/0203310 A1
(43) Pub. Date: Jul. 20, 2017

(54) NOZZLE ARRANGEMENT FOR LIQUID

(71) Applicant: Alfred Kärcher GmbH & Co. KG, Winnenden (DE)

(72) Inventors: David Ruckwied, Asperg (DE); Christian Langer, Noerdlingen (DE)

(21) Appl. No.: 15/476,143

(22) Filed: Mar. 31, 2017

Related U.S. Application Data
(63) Continuation of application No. PCT/EP2014/071211, filed on Oct. 2, 2014.

(51) Int. Cl. B05B 1/16; B08B 3/02; B05B 1/04

(52) U.S. Cl. CPC B05B 1/1609; B05B 1/042; B08B 3/02

(57) ABSTRACT

A nozzle arrangement includes a nozzle inlet part having an inlet duct for liquid under pressure, and a nozzle outlet part which is displaceable relative to the nozzle inlet part between a first and second position and which has a high-pressure nozzle and a low-pressure nozzle each configured as a fan-jet nozzle. In the first position, only the high-pressure nozzle is connected to the inlet duct and in the second position the high-pressure and the low-pressure nozzles are connected to the inlet duct. The at least one low-pressure nozzle is arranged radially offset to the high-pressure nozzle, and the nozzle outlet part has a connecting nipple via which the high-pressure nozzle is in a flow connection with the inlet duct and which interrupts or allows a flow connection of the inlet duct with the low-pressure nozzle depending on whether the nozzle outlet part is in the first or second position.

### CROSS REFERENCE TO RELATED APPLICATIONS

This application is a continuation of international application number PCT/EP2014/071211 filed on Oct. 2, 2014, which is incorporated herein by reference in its entirety and for all purposes.

### BACKGROUND OF THE INVENTION

The invention relates to a nozzle arrangement for liquid, with a nozzle inlet part which has an inlet duct for liquid under pressure, and with a nozzle outlet part which is displaceable continuously back and forth relative to the nozzle inlet part between a first position and a second position and which has a high-pressure nozzle formed as a fan-jet nozzle and at least one low-pressure nozzle formed as a fan-jet nozzle, wherein in the first position only the high-pressure nozzle is in a flow connection with the inlet duct and wherein in the second position the high-pressure nozzle and the at least one low-pressure nozzle are in a flow connection with the inlet duct.

By means of such nozzle arrangements, a liquid under pressure, for example water, can be directed onto a surface. The liquid under pressure can be supplied to the nozzle arrangement for example via a spray lance from a high-pressure cleaning appliance or a similar appliance. The liquid under pressure is discharged from the nozzle arrangement in the form of a fan jet. With the aid of the fan jet, a large surface can be exposed to liquid within a short time, for example in order to clean the surface, but the pressure of the liquid has to be reduced in the case of sensitive surfaces in order to avoid damage.

A nozzle arrangement with a nozzle inlet part and a nozzle outlet part which is displaceable relative to the nozzle inlet part is known from EP 0 501 164 A1. The nozzle outlet part has, in addition to a high-pressure nozzle, two exit bores arranged symmetrically to the high-pressure nozzle. The nozzle outlet part can assume a first position relative to the nozzle inlet part in which the liquid supplied to the nozzle inlet part via a spray lance is discharged merely via the high-pressure nozzle, so that the discharged liquid is at a high pressure. Furthermore, the nozzle outlet part may assume a second position in which the liquid can be discharged not only via the high-pressure nozzle but also via the outlet bores, so that the liquid discharged overall is at a relatively low pressure. It is not possible continuously to change the pressure of the discharged liquid with this nozzle arrangement since the nozzle outlet part can assume either only the first position or the second position. The liquid in this case is discharged from the high-pressure nozzle and from the outlet bores in the form of a spot jet.

A nozzle arrangement of the type referred to first hereinbefore is known from EP 1 569 755 B1. The nozzle outlet part has a high-pressure nozzle configured as a fan-jet nozzle and a low-pressure nozzle, arranged coaxially to the high-pressure nozzle, which is likewise formed as a fan-jet nozzle. The nozzle inlet part comprises an inlet duct, to which liquid under pressure can be supplied via a spray lance. In a first position of the nozzle outlet part, merely the high-pressure nozzle is in a flow connection with the inlet duct, so that liquid under high pressure can be discharged from the high-pressure nozzle. In the first position of the nozzle outlet part, the flow connection between the inlet duct and the low-pressure nozzle is interrupted. By displacing the nozzle outlet part from the first position into the second position, a path of flow from the inlet duct to the low-pressure nozzle is unblocked, the flow cross-section of the path of flow widening continuously upon displacement of the nozzle outlet part into the second position. The liquid supplied to the nozzle inlet part can thus be discharged via the high-pressure nozzle and also via the low-pressure nozzle. This makes it possible continuously to change the pressure of the discharged liquid while the delivery remains constant. However, the known nozzle arrangement has a non-linear regulation characteristic, that is to say that the pressure of the liquid discharged changes unevenly upon even displacement of the nozzle outlet part. This makes it more difficult to set a desired pressure reproducibly. Furthermore, with the known nozzle arrangement the spray pattern of the discharged liquid changes, that is to say that the geometry of the fan jet changes upon displacement of the nozzle outlet part.

It is an object of the present invention to improve a nozzle arrangement of the type referred to first hereinbefore such that the pressure of the discharged liquid can be changed evenly while the delivery remains constant and changes to the spray pattern remain as slight as possible.

### SUMMARY OF THE INVENTION

This object is achieved according to the invention in a nozzle arrangement of the generic type in that the at least one low-pressure nozzle is arranged radially offset to the high-pressure nozzle and the nozzle outlet part has a connecting nipple via which the high-pressure nozzle, independently of the position of the nozzle outlet part, is in a flow connection with the inlet duct and which in the first position of the nozzle outlet part interrupts a flow connection of the inlet duct with the at least one low-pressure nozzle, and which upon the transition of the nozzle outlet part from the first position into the second position unblocks an increasing annular gap of adjustable width, via which the inlet duct is in a flow connection with the at least one low-pressure nozzle.

In the nozzle arrangement according to the invention, the at least one low-pressure nozzle is arranged radially offset to the high-pressure nozzle. Because of the higher flow velocity of the liquid jet discharged from the high-pressure nozzle, the liquid jet discharged from the at least one low-pressure nozzle is deflected in the direction of the liquid jet of the high-pressure nozzle. The consequence of this is that the fan jet discharged from the low-pressure nozzle is combined at a short distance from the high-pressure nozzle with the fan jet discharged from the high-pressure nozzle, so that a common fan jet is formed. The geometry of the common fan jet and hence the spray pattern of the liquid discharged from the nozzle arrangement at most undergoes a very slight change upon the transition of the nozzle outlet part from the first position into the second position.

The nozzle outlet part has a connecting nipple which is arranged upstream from the high-pressure nozzle and is permanently in a flow connection with the high-pressure nozzle independently of the position of the nozzle outlet part. In the first position of the nozzle outlet part, the connecting nipple interrupts the flow connection from the connection duct to the at least one low-pressure nozzle. Beneficially, the connecting nipple in the first position of the nozzle outlet part lies in liquid-tight manner against an exit portion of the inlet duct. Liquid supplied to the inlet duct can reach the high-pressure nozzle via the connecting nipple, but not the at least one low-pressure nozzle, in the first position of the nozzle outlet part. Upon the transition of the nozzle outlet part from the first position into the second position, the connecting nipple unblocks an annular gap. The annular gap allows a path of flow from the inlet duct to the at least one low-pressure nozzle, so that liquid can reach not only the high-pressure nozzle but also the at least one low-pressure nozzle. The width of the annular gap increases upon the transition of the nozzle outlet part from the first position into the second position. The consequence of this is that the flow rate of the liquid flowing to the at least one low-pressure nozzle is increased. It has been shown that due to such a configuration the pressure of the discharged liquid can be changed evenly over a large range of adjustment while the delivery remains constant.

Preferably the width of the annular gap upon the transition of the nozzle outlet part from the first position into the second position increases continuously, in particular in infinitely variable manner, so that the flow rate of the liquid which flows to the at least one low-pressure nozzle also increases continuously, in particular in infinitely variable manner.

Provision may be made for the nozzle outlet part only to be able to be displaced if it is not being exposed to liquid under pressure, i.e., if no liquid under pressure is flowing through the nozzle arrangement. Preferably the nozzle outlet part is however also displaceable when it is exposed to liquid under pressure, i.e., during operation of the nozzle arrangement.

The nozzle arrangement according to the invention makes it possible for example to change the pressure of the discharged liquid practically linearly in a range of adjustment between approx. 200bar and approx. 10 to 20 bar while the delivery remains constant. The constant delivery may for example amount to 11 to 12 l/min and the discharged liquid practically forms a constant fan-shaped fan jet.

The nozzle arrangement according to the invention enables the user to set the pressure of the discharged liquid reproducibly while the delivery remains constant and the spray pattern remains practically the same. This facilitates handling of the nozzle arrangement.

It is beneficial if the direction of emergence of liquid of the at least one low-pressure nozzle is inclined towards the direction of emergence of liquid of the high-pressure nozzle. The liquid discharged from the at least one low-pressure nozzle is thus directed at the liquid which is discharged from the high-pressure nozzle. This ensures a spray pattern which undergoes practically no change upon the transition of the nozzle outlet part from the first position into the second position.

Preferably the liquid flowing through the annular gap can be supplied to the at least one low-pressure nozzle without reversing the direction of flow. With such a configuration, the liquid on its way from the inlet duct to the at least one low-pressure nozzle is guided along the outside of the connecting nipple, without undergoing a reversal of direction. The risk of the liquid forming eddies and/or what are called “dead spots”, which might adversely affect the regulation characteristic of the nozzle arrangement, in the region between the inlet duct and the at least one low-pressure nozzle is thereby kept particularly low.

The connecting nipple is beneficially oriented flush with the high-pressure nozzle, because flow losses can thereby be kept low.

It is advantageous if the nozzle outlet part has a nozzle body which forms the high-pressure nozzle and the at least one low-pressure nozzle. The high-pressure nozzle and the at least one low-pressure nozzle are thus formed by a one-part component. This facilitates the assembly of the nozzle arrangement and reduces the production costs thereof.

It is particularly beneficial if the connecting nipple projects out of a rear side of the nozzle body which faces the inlet duct. If the nozzle outlet part, starting from the first position, is displaced in the direction of the second position, the connecting nipple unblocks an annular gap which in the case of such a configuration is delimited on one hand by an end region of the connecting nipple and on the other hand by an end region of the inlet duct, and the width of which increases continuously upon displacement of the nozzle outlet part from the first position into the second position.

In an advantageous configuration of the invention, the connecting nipple is pressed or glued into the nozzle body. This results in a further simplification of the assembly of the nozzle arrangement and reduces the production costs thereof.

An exit portion of the inlet duct in a preferred configuration of the invention has a sealing face which widens conically in the direction of flow of the liquid, against which face the connecting nipple lies in liquid-tight manner in the first position of the nozzle outlet part. Preferably a wall of the connecting nipple in the first position of the nozzle outlet part lies directly, i.e., without the interposition of an additional sealing element, for example a sealing ring, against a wall of the inlet duct.

Upstream from the conical sealing face, the inlet duct beneficially has a cylindrical duct portion. Upstream from the cylindrical duct portion, there is beneficially arranged a further duct portion of the entry duct, the flow cross-section of which portion decreases continuously in the direction of flow of the liquid.

An entry portion of the inlet duct is preferably cylindrical and receives an end portion of a spray lance, via which liquid under pressure can be supplied to the inlet duct.

The spray lance is beneficially soldered into the entry portion of the inlet duct.

It is advantageous if the connecting nipple has an annular bead which in the first position of the nozzle outlet part lies in liquid-tight manner against the sealing face of the inlet duct. The annular bead permits liquid-tight sealing between the inlet duct and the connecting nipple in a structurally simple manner, without an additional sealing element, for example a sealing ring made of an elastomeric material, having to be used.

The surface of the annular bead is preferably curved in arcuate manner.

In an advantageous embodiment of the invention, a widened portion of the connecting nipple adjoins the annular bead in the direction of flow of the liquid, in which the external diameter of the connecting nipple widens continuously in the direction of flow of the liquid. Preferably the widened portion is formed to be conical.

Upstream from the annular bead, in an advantageous configuration of the invention there is arranged an entry portion of the connecting nipple, the entry portion in the first position of the nozzle outlet part extending into a preferably cylindrically configured portion of the inlet duct. The external diameter of the entry portion in this case may be selected to be slightly smaller than the internal diameter of the portion of the inlet duct which receives the entry portion.

It is advantageous if the external diameter of the entry portion tapers continuously in the direction remote from the annular bead, i.e., in the direction of the free end of the entry portion.

Preferably the entry portion forms on its outside a large number of successive conical faces, the inclination of which to the central axis of the entry duct increases with increasing distance from the annular bead. A first conical face which directly adjoins the annular bead is inclined only at a small angle to the central axis, in particular at an angle of at most 5°, and with increasing distance from the annular bead the successive conical faces have an angle of inclination which becomes larger. The maximum angle of inclination is preferably 45° to 65°. The entry portion may for example have 4 to 8 conical faces with different inclinations to the central axis.

In an advantageous configuration of the nozzle arrangement according to the invention, the nozzle outlet part has a first and at least one second through-channel which are arranged parallel to each other, with the high-pressure nozzle being arranged at the downstream end of the first through-channel and with a low-pressure nozzle being arranged at the downstream end of the at least one second through-channel. The liquid is thus supplied to the high-pressure nozzle and the at least one low-pressure nozzle via through-channels which are oriented parallel to each other. The parallel orientation of the through-channels makes it possible to produce the nozzle outlet part inexpensively.

The connecting nipple in an advantageous configuration extends into the first through-channel.

It is advantageous if the connecting nipple is pressed or glued into the first through-channel.

It is beneficial if the first through-channel is formed stepped and has a cylindrical first duct portion into which the connecting nipple extends and which is adjoined via an inwards-directed step by a second cylindrical duct portion, the internal diameter of which is preferably identical to the internal diameter which the connecting nipple has in its downstream end region. Beneficially, a conical duct portion of the first through-channel adjoins the second cylindrical duct portion. In the conical duct portion, the internal diameter of the first through-channel decreases continuously in the direction of flow of the liquid. The high-pressure nozzle may be arranged on or in the conical duct portion.

The high-pressure nozzle is beneficially configured as an end region of the first through-channel which tapers continuously in the direction of flow of the liquid, the end region having two pocket-shaped enlarged portions lying diametrically opposite each other which are adjoined in the direction of flow of the liquid by a circular outlet opening. The end region of the first through-channel may for example be configured to be conical. In the region of the pocket-shaped enlarged portions which lie diametrically opposite each other, the liquid undergoes a deflection so that it then forms a fan jet. The pocket-shaped enlarged portions may form partially spherical deflecting faces for this purpose. Fan-jet nozzles with pocket-shaped enlarged portions are known to the person skilled in the art for example from WO 94/17921 A1.

The at least one low-pressure nozzle in an advantageous configuration of the invention is configured as an end region of a second through-channel which tapers continuously and which is adjoined in the direction of flow of the liquid by a slot-shaped outlet opening, the slot-shaped outlet opening in the direction towards the high-pressure nozzle being arranged offset to the longitudinal axis of the second through-channel. The end region of the second through-channel may for example be configured to be conical or in the form of a partial sphere. The slot-shaped outlet opening eccentrically intersects the continuously tapering end region of the second through-channel. On flowing through the slot-shaped outlet opening, the liquid forms a fan jet. Since the slot-shaped outlet opening is arranged offset to the longitudinal axis of the second through-channel, the fan jet is inclined in the direction of the high-pressure nozzle. The consequence of this is that the fan jet discharged from the at least one low-pressure nozzle is combined with the fan jet discharged from the at least one high-pressure nozzle to form a common fan jet, the geometry of which practically does not change upon displacement of the nozzle outlet part from the first position into the second position.

It is particularly advantageous if the nozzle outlet part has at least two low-pressure nozzles arranged symmetrically to the high-pressure nozzle, each of which are formed as fan-jet nozzles. The high-pressure nozzle is thus positioned between at least two low-pressure nozzles arranged symmetrically to the high-pressure nozzle. In the first position of the nozzle outlet part, the liquid is discharged via the high-pressure nozzle in the form of a fan jet. If the nozzle outlet part is displaced from the first position into the second position, an increasing proportion of the liquid supplied is discharged via the low-pressure nozzles, with the fan jets of the low-pressure nozzles combining with the fan jet of the high-pressure nozzle to form a common fan jet.

Preferably the nozzle inlet part has a cutout into which the inlet duct opens and in which the nozzle outlet part is displaceably held.

The nozzle outlet part may have on its outside an annular groove in which a sealing ring is arranged which lies in liquid-tight manner against a wall of the cutout of the nozzle inlet part.

The nozzle outlet part is beneficially held in the cutout in rotation-resistant manner. This ensures that the nozzle outlet part can merely be displaced axially but not also turned, relative to the nozzle inlet part.

An eccentrically arranged locking pin which extends into bores of the nozzle inlet part and of the nozzle outlet part which are oriented flush with each other may be used to secure the nozzle outlet part against turning. The locking pin ensures in a structurally simple manner that the nozzle outlet part cannot be turned relative to the nozzle inlet part.

In order to be able to displace the nozzle outlet part reproducibly relative to the nozzle inlet part, the nozzle arrangement in a particularly preferred configuration of the invention has a rotary part which is mounted rotatably and axially displaceably on the nozzle inlet part via a thread and which has an entraining element for displacing the nozzle outlet part. The rotary part surrounds the nozzle inlet part in the peripheral direction and can be turned relative to the nozzle inlet part about the longitudinal axis thereof. Since the rotary part is connected to the nozzle inlet part via a thread, a rotary movement of the rotary part also results in axial displacement of the rotary part relative to the nozzle inlet part. This displacement movement is transmitted from the rotary part via the entraining element to the nozzle outlet part which is held non-rotatably in the cutout of the nozzle inlet part.

The nozzle outlet part preferably has a flange protruding radially outwards, with which the entraining element of the rotary part is engaged.

It is beneficial if the nozzle arrangement according to the invention has two housing half-shells which surround the rotary part and are connected in rotation-resistant manner to the rotary part. This gives the user the possibility of displacing the nozzle outlet part relative to the nozzle inlet part by turning the two housing half-shells together with the rotary part about the longitudinal axis of the nozzle arrangement.

The two housing half-shells may be held rotatably on a spray lance which is connected to the nozzle inlet part in rotation-resistant manner.

The following description of an advantageous embodiment of the invention serves to explain it in greater detail in conjunction with the drawings.

### BRIEF DESCRIPTION OF THE DRAWINGS

FIG. 1 is a longitudinal sectional view of a nozzle arrangement, with a nozzle outlet part assuming a first position;

FIG. 2 is a longitudinal sectional view of the nozzle arrangement corresponding to FIG. 1, with the nozzle outlet part assuming a second position;

FIG. 3 is a longitudinal sectional view of the nozzle arrangement along the line 3-3 in FIG. 1;

FIG. 4 is a longitudinal sectional view of the nozzle outlet part of FIG. 1;

FIG. 5 is a perspective view of the nozzle outlet part of FIG. 1 together with the fan jet discharged from the nozzle arrangement;

FIG. 6 is an enlarged partial sectional view of a connecting nipple of the nozzle outlet part, with the nozzle outlet part assuming its first position;

FIG. 7 is an enlarged partial sectional view of the connecting nipple of the nozzle outlet part, with the nozzle outlet part assuming an intermediate position; and

FIG. 8 is an enlarged partial sectional view of the connecting nipple of the nozzle outlet part, with the nozzle outlet part assuming its second position.

### DETAILED DESCRIPTION OF THE INVENTION

The drawings show schematically an advantageous embodiment of a nozzle arrangement according to the invention which is assigned overall the reference numeral 10. As will be explained in greater detail below, the nozzle arrangement 10 can be supplied with liquid under pressure (not shown in the drawings), which is discharged from the nozzle arrangement 10 in the form of a fan jet. The nozzle arrangement 10 has a nozzle inlet part 12 and a nozzle outlet part 16 which is displaceable relative to the nozzle inlet part 12 coaxially to the longitudinal axis 14 of the nozzle arrangement. The nozzle inlet part 12 has a cutout 18 with a base wall 20 and a cylindrical side wall 22. The nozzle outlet part 16 extends into the cutout 18 and is mounted in the cutout 18 so as to be displaceable in the direction of the longitudinal axis 14. The cutout 18 extends as far as a front side 24 of the nozzle inlet part 12. The nozzle outlet part 16 projects out of the cutout 18 with a front end portion 26.

Into the base wall 20 of the cutout 18 there opens an inlet duct 28 which extends from a rear side 30 of the nozzle inlet part 12 as far as the cutout 18. Starting from the rear side 30, the inlet duct 28 has a cylindrical entry portion 32 which is adjoined, via a step 34 directed radially inwards, by a conical duct portion 36, the flow cross-section of which decreases continuously with increasing distance from the step 34. The conical duct portion 36 is adjoined by a cylindrical duct portion 38. The cylindrical duct portion is adjoined by an exit portion 40, the flow cross-section of which widens continuously with increasing distance from the cylindrical duct portion 38, and which forms a conical sealing face 42.

The entry portion 32 of the inlet duct 28 receives an end region of a spray lance 44 which is soldered into the entry portion 32. The inlet duct 28 can be supplied with liquid under pressure, for example water under pressure, via the spray lance 44. The spray lance 44 for this purpose may be connected via a supply line not shown in the drawings, for example a pressure hose, to a high-pressure cleaning appliance which is known per se.

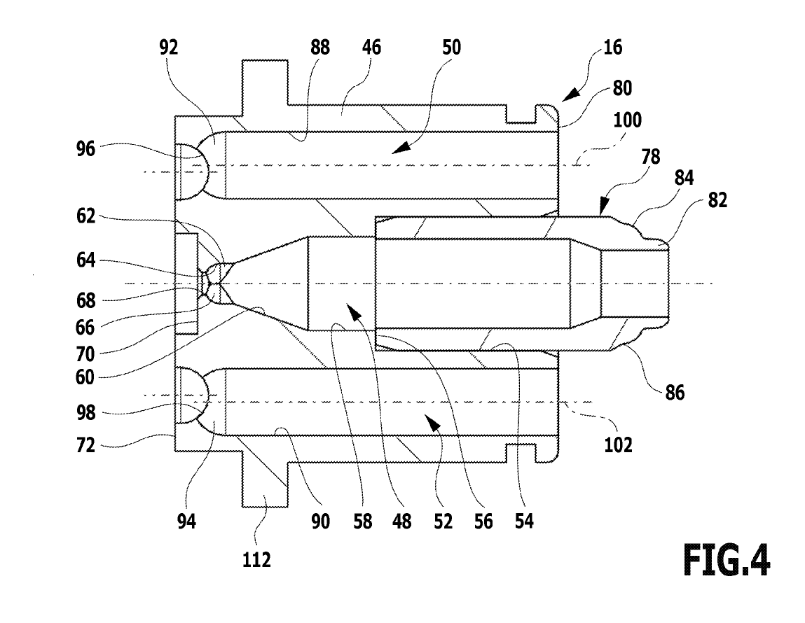

The nozzle outlet part 16 is shown enlarged in FIG. 4. It has a one-part nozzle body 46, which has a first through-bore 48 oriented coaxially to the longitudinal axis 14 and two second through-bores 50, 52 arranged radially offset to the first through-bore 48 and oriented parallel to the first through-bore 48 and positioned symmetrically to the first through-bore 48. The first through-bore 48 forms a first through-channel of the nozzle body 46 and the second through-bores 50, 52 in each case form a second through-channel of the nozzle body 46.

The first through-bore 48 has a first cylindrical bore portion 54 which merges into a second cylindrical bore portion 58 via a step 56 directed radially inwards. The bore portion 58 is adjoined by a conical third bore portion 60, the flow cross-section of which decreases continuously with increasing distance from the second bore portion 58. The third bore portion 60 extends as far as a circular outlet opening 68, via which the first through-bore 48 is in a flow connection with a recess 70 on the end face. The recess 70 is formed in a front side 72 of the nozzle body 4 which is remote from the base wall 20 of the cutout 18.

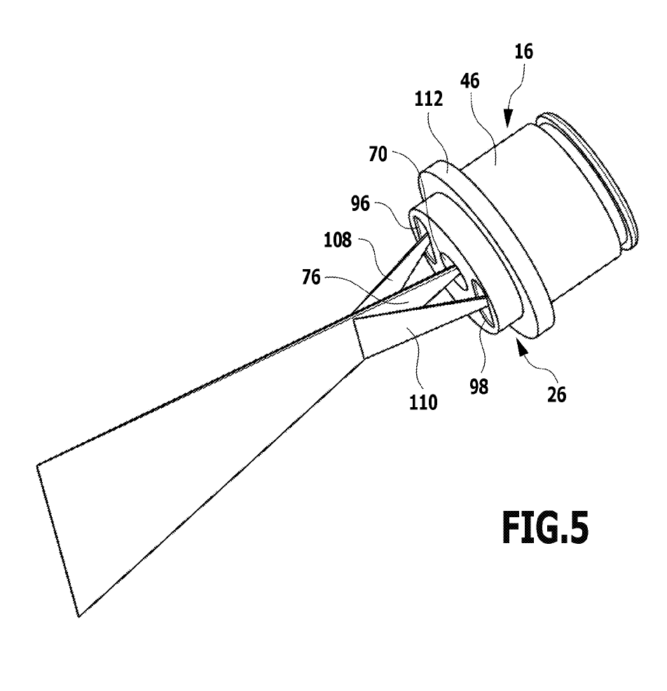

Directly upstream from the outlet opening 68, the third bore portion 60 has in an end region 62 two pocket-shaped enlarged portions 64, 66 lying diametrically opposite each other, which in each case form a partially-spherical deflecting face. The two pocket-shaped enlarged portions 64, 66 in combination with the outlet opening 68 form a high-pressure nozzle 74 which discharges liquid in the form of a central fan jet 76 illustrated schematically in FIG. 5.

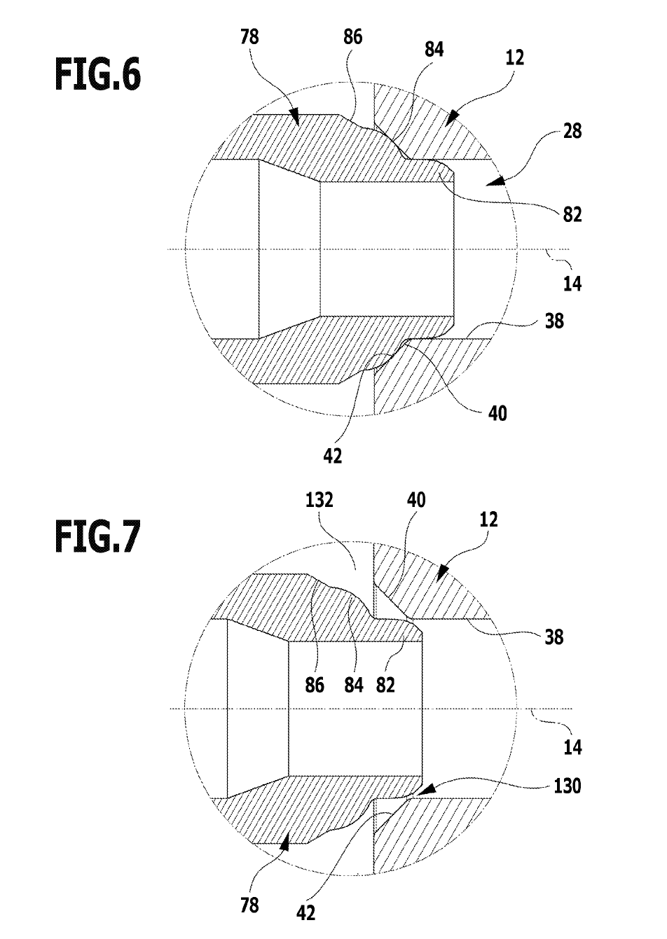

Into the first bore portion 54 is pressed a connecting nipple 78 of the nozzle outlet part 16, which nipple projects out of a rear side 80 of the nozzle body 46 which faces the base wall 20 of the cutout 18. The connecting nipple 78 has at its end remote from the nozzle body 46 an entry portion 82 which tapers increasingly in the direction of its free end, which portion is adjoined by an annular bead 84 in the direction of the nozzle body 46. The outside of the entry portion 82 is formed by a plurality of successive conical faces, the inclination of which to the central axis of the entry portion 82 and hence relative to the longitudinal axis 14 increases with increasing distance from the annular bead 84. The surface of the annular bead 84 is curved in arcuate manner. This becomes clear in particular from FIGS. 6, 7 and 8. The annular bead 84 is adjoined in the direction of the nozzle body 46 by a widened portion 86, the external diameter of which widens conically in the direction of the nozzle body 46.

The second through-bores 50 and 52 are formed identically and have in each case a cylindrical bore portion 88 or 90 respectively, which are adjoined by an end region 92 or 94 respectively, the flow cross-sections of which portions decrease with increasing distance from the cylindrical bore portion 88, 90. In the example of embodiment illustrated, the end regions 92, 94 are configured to be partially spherical; alternatively, they could for example also be configured to be conical. The end regions 92, 94 are adjoined in each case by a slot-shaped outlet opening 96 or 98 respectively, which are arranged in the direction of the high-pressure nozzle 74 offset to the longitudinal axis 100 or 102 of the second through-bores 50, 52 respectively. The end region 92 in combination with the slot-shaped outlet opening 96 forms a first low-pressure nozzle 104, and the end region 94 in combination with the slot-shaped outlet opening 98 forms a second low-pressure nozzle 106. Liquid is discharged in the form of a first lateral fan jet 108 from the first low-pressure nozzle 104, and liquid is discharged in the form of a second lateral fan jet 110 from the second low-pressure nozzle 106. The two lateral fan jets 108 and 110 are inclined towards the longitudinal axis 14 and hence towards the central fan jet 76, and combine with the central fan jet 76 at a short distance from the high-pressure nozzle 74. The distance is preferably shorter than the total length of the nozzle body 46. This becomes clear from FIG. 5.

At the level of the front end portion 26, the nozzle body 46 has a flange 112 which protrudes radially outwards and which is encompassed by an entraining element 114 of a sleeve-shaped rotary part 116. The rotary part 116 surrounds the nozzle inlet part 12 in the peripheral direction and the entraining element 114 forms an end portion of the rotary part 116 which projects axially past the nozzle inlet part 12. The rotary part 116 is mounted rotatably and axially displaceably on the nozzle inlet part 12 by means of a thread 118. Via the entraining element 114, the rotary part 116 is engaged with the flange 112, the rotary part 116 being rotatable about the longitudinal axis 14 relative to the flange 112, but an axial movement of the rotary part 116 is transmitted to the flange 112.

The nozzle outlet part 46 is held in rotation-resistant manner in the cutout 18 of the nozzle inlet part 12. An anti-turning means in the form of a locking pin 120 which is oriented parallel to the longitudinal axis 14 and extends with a front pin portion 122 into a blind hole 124 of the nozzle body 46 and with a rear pin portion 126 into a blind hole 128 of the nozzle inlet part 12 is used for this purpose. The blind hole 124 of the nozzle body 46 is oriented flush with the blind hole 128 of the nozzle inlet part 12.

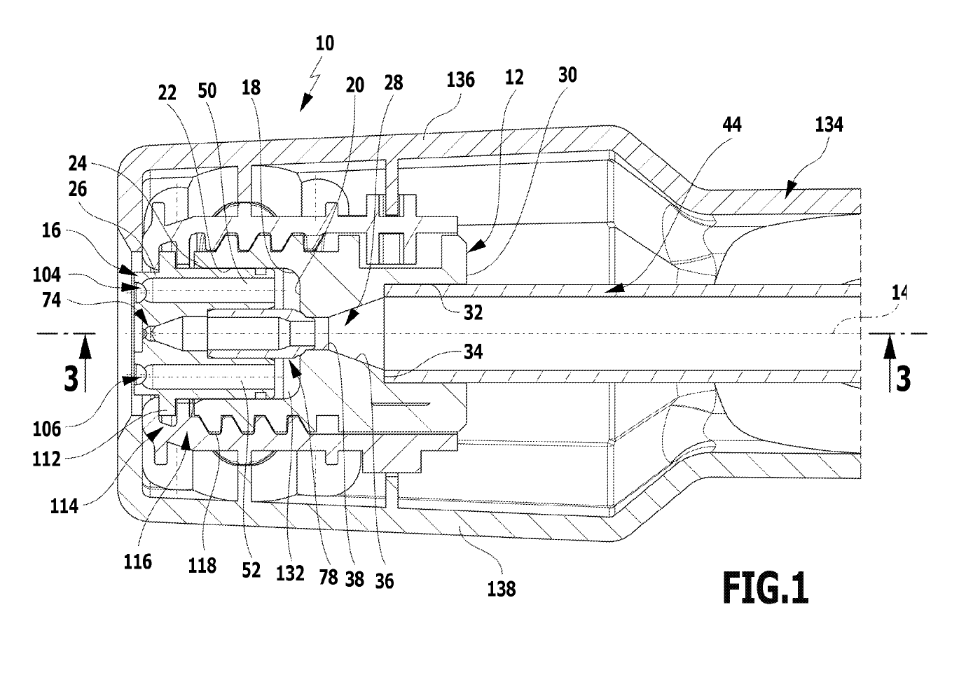

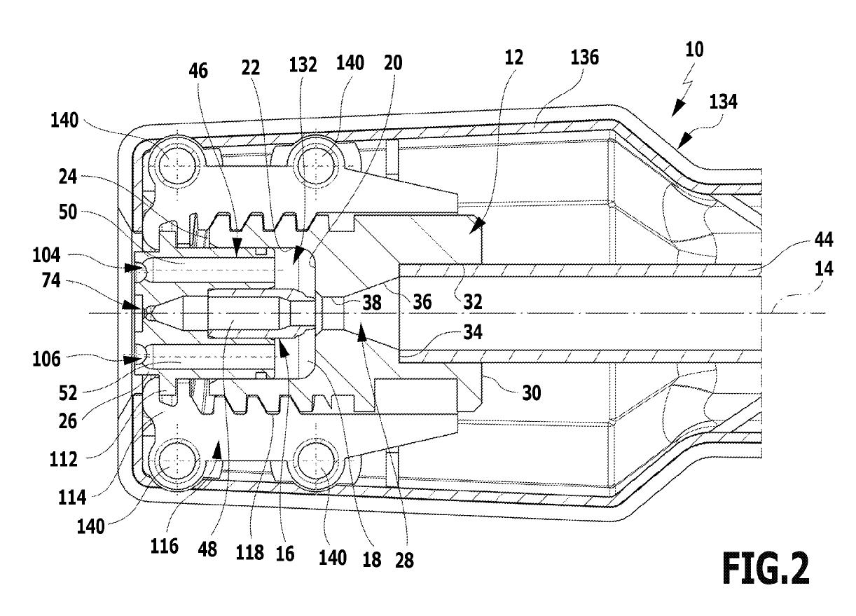

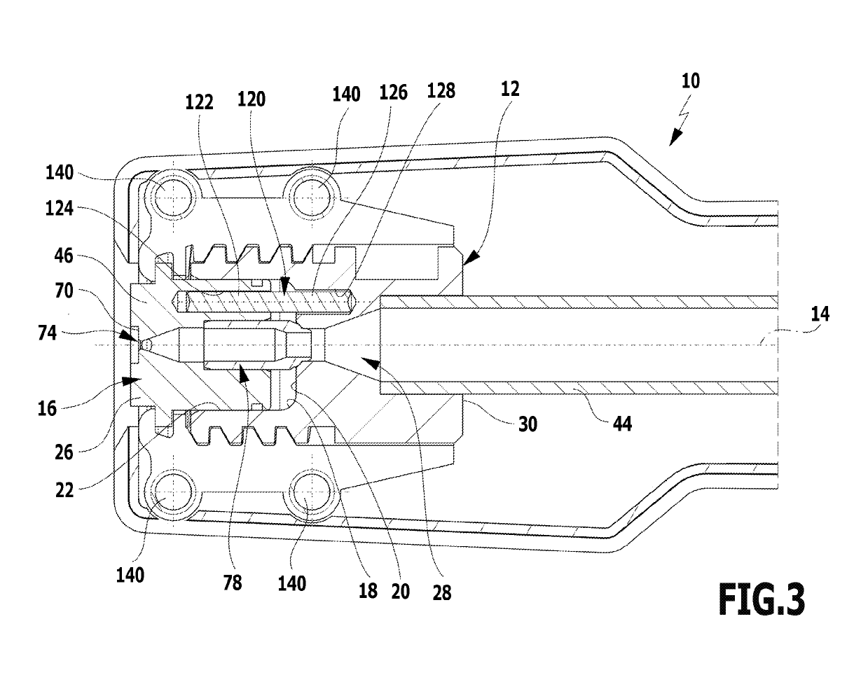

If the rotary part 116 is turned about the longitudinal axis 14 relative to the nozzle inlet part 12, it performs an axial movement which is transmitted via the entraining element 114 and the flange 112 to the nozzle outlet part 16. In this manner, the nozzle outlet part 16 can be displaced continuously back and forth between a first position illustrated in FIG. 1 and a second position illustrated in FIG. 2. In the first position, the entry portion 82 of the connecting nipple 78 extends into the cylindrical duct portion 38 of the inlet duct 28, and the annular bead 84 of the connecting nipple 78 lies in liquid-tight manner against the conical sealing face of the inlet duct 28. This becomes clear in particular from FIG. 6. In this first position of the nozzle outlet part 16, the inlet duct 28 is in a flow connection merely with the first through-bore 48 and the high-pressure nozzle 74, while the flow connection between the inlet duct 28 and the second through-bores 50, 52 is interrupted because of the liquid-tight contact of the annular bead 84 against the sealing face 42.

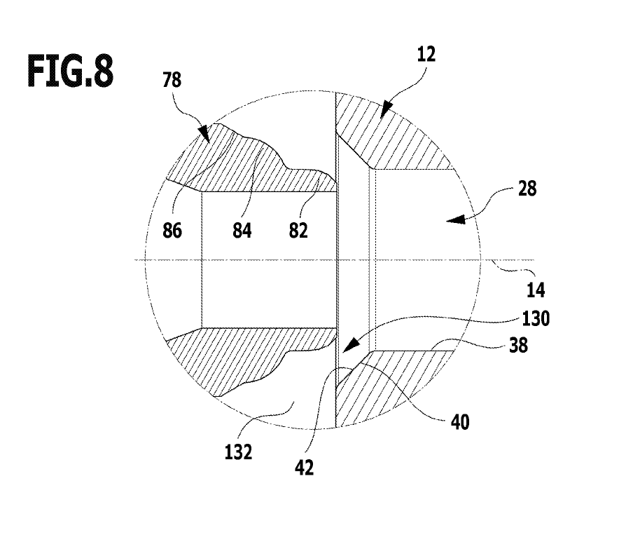

If the nozzle outlet part 16, starting from the first position, is displaced continuously into the second position illustrated in FIG. 2, the connecting nipple 78 unblocks an annular gap 130, the width of which widens continuously upon the transition of the nozzle outlet part 16 out of the first position into the second position. This becomes clear in particular from FIGS. 7 and 8. Via the annular gap 130, the inlet duct 28 is in a flow connection with an annular space 132 which surrounds the region of the connecting nipple 78 which projects out of the nozzle body 46 in the peripheral direction and which is adjoined in the direction of flow of the liquid by the second through-bores 50, 52. The annular space 132 is delimited in the axial direction by the base wall 20 of the cutout 18 and the rear side 80 of the nozzle body 46, and in the radial direction the annular space 132 is delimited by the connecting nipple 78 and the side wall 22 of the cutout 18.

Upon the transition of the nozzle outlet part 16 from the first position into the second position, a path of flow from the inlet duct 28 to the low-pressure nozzles 104, 106 is unblocked via the annular gap 130, the annular space 132 and the second through-bores 50, 52, so that liquid under pressure can be supplied to the low-pressure nozzles 104, 106.

The rotary part 116 is surrounded by a housing 134 of the nozzle arrangement 10. The housing 134 is formed of a first housing half-shell 136 and a second housing half-shell 138 which are connected in rotation-resistant manner to the rotary part 116. In the example of embodiment illustrated, the two housing half-shells 136, 138 are screwed to the rotary part 116 via connecting screws 140.

The housing half-shells 136, 138 can be turned by the user relative to the spray lance 44 about the longitudinal axis 14 of the nozzle arrangement 10. The rotary movement is transmitted to the rotary part 116 via the connecting screws 140, and the nozzle outlet part 16, as discussed above in detail, can be displaced continuously back and forth relative to the nozzle inlet part 12 between the first position illustrated in FIG. 1 and the second position illustrated in FIG. 2 by turning the rotary part 116. Liquid under pressure, which is supplied via the spray lance 44 to the nozzle inlet part 12 which is connected in rotation-resistant manner to the spray lance 44, in the first position of the nozzle outlet part 16 is merely discharged via the high-pressure nozzle 74 in the form of the central fan jet 76. If the nozzle outlet part 16, starting from its first position, is displaced in the direction of its second position, liquid is discharged not only via the high-pressure nozzle 74 but additionally also via the low-pressure nozzles 104, 106, with the lateral fan jets 108, 110 combining with the central fan jet 76 at a short distance from the high-pressure nozzle 74.

The nozzle arrangement 10 gives the user the possibility of reproducibly setting the pressure of the discharged liquid while the delivery remains constant. For this purpose, the user merely has to position the two housing half-shells 136, 138 in a desired rotary position which corresponds to a particular position of the nozzle outlet part 16 relative to the nozzle inlet part 12 and hence to a certain width of the annular gap 130. The user has for example the possibility of selecting a pressure in the range of 200 bar to approximately 10 bar for the discharged liquid. In this range of adjustment of the nozzle arrangement 10, a change in the pressure of the discharged liquid while the delivery of the liquid remains constant does not result in any significant change in the spray pattern of the liquid. The positioning of the nozzle outlet part 16 can be changed by the user during operation of the nozzle arrangement 10, i.e., the nozzle outlet part 16 can be displaced while being exposed to liquid under pressure.

1. A nozzle arrangement, with a nozzle inlet part which has an inlet duct for liquid under pressure, and with a nozzle outlet part which is displaceable continuously back and forth relative to the nozzle inlet part between a first position and a second position and which has a high-pressure nozzle formed as a fan-jet nozzle and at least one low-pressure nozzle formed as a fan-jet nozzle, wherein in the first position only the high-pressure nozzle is in a flow connection with the inlet duct and wherein in the second position the high-pressure nozzle and the at least one low-pressure nozzle are in a flow connection with the inlet duct, wherein the at least one low-pressure nozzle is arranged radially offset to the high-pressure nozzle and the nozzle outlet part has a connecting nipple which independently of the position of the nozzle outlet part is in a flow connection with the high-pressure nozzle and which in the first position of the nozzle outlet part interrupts a flow connection of the inlet duct with the at least one low-pressure nozzle, and which upon the transition of the nozzle outlet part from the first position into the second position unblocks an increasing annular gap of adjustable width, via which the inlet duct is in a flow connection with the at least one low-pressure nozzle.

2. The nozzle arrangement according to claim 1, wherein the direction of emergence of liquid of the at least one low-pressure nozzle is inclined towards the direction of emergence of liquid of the high-pressure nozzle.

3. The nozzle arrangement according to claim 1, wherein the connecting nipple in the first position of the nozzle outlet part lies in liquid-tight manner against an exit portion of the inlet duct.

4. The nozzle arrangement according to claim 1, wherein the liquid flowing through the annular gap can be supplied to the at least one low-pressure nozzle without reversing the direction of flow.

5. The nozzle arrangement according to claim 1, wherein the connecting nipple is oriented flush with the high-pressure nozzle.

6. The nozzle arrangement according to claim 1, wherein the nozzle outlet part has a nozzle body which forms the high-pressure nozzle and the at least one low-pressure nozzle.

7. The nozzle arrangement according to claim 6, wherein the connecting nipple projects out of a rear side of the nozzle body which faces the inlet duct.

8. The nozzle arrangement according to claim 6, wherein the connecting nipple is pressed into the nozzle body.

9. The nozzle arrangement according claim 3, wherein the exit portion of the inlet duct has a sealing face which widens conically in the direction of flow of the liquid, against which face the connecting nipple lies in liquid-tight manner in the first position of the nozzle outlet part.

10. The nozzle arrangement according to claim 9, wherein the connecting nipple has an annular bead which in the first position of the nozzle outlet part lies in liquid-tight manner against the sealing face.

11. The nozzle arrangement according to claim 10, wherein the surface of the annular bead is curved in arcuate manner.

12. The nozzle arrangement according to claim 10, wherein the connecting nipple has an entry portion arranged upstream from the annular bead, which portion in the first position of the nozzle outlet part extends into a cylindrical duct portion of the inlet duct.

13. The nozzle arrangement according to claim 12, wherein the external diameter of the entry portion tapers with increasing distance from the annular bead.

14. The nozzle arrangement according to claim 1, wherein the nozzle outlet part has a first and at least one second through-channel which are arranged parallel to each other, with the high-pressure nozzle being arranged at the downstream end of the first through-channel and a low-pressure nozzle being arranged at the downstream end of the at least one second through-channel.

15. The nozzle arrangement according to claim 14, wherein the connecting nipple extends into the first through-channel.

16. The nozzle arrangement according to claim 14, wherein the high-pressure nozzle is configured as an end region of the first through-channel which tapers continuously in the direction of flow of the liquid, the end region having two pocket-shaped enlarged portions lying diametrically opposite each other which are adjoined in the direction of flow of the liquid by a circular outlet opening.

17. The nozzle arrangement according to claim 14, wherein the at least one low-pressure nozzle is configured as an end region of a second through-channel which tapers continuously in the direction of flow of the liquid and which is adjoined in the direction of flow of the liquid by a slot-shaped outlet opening, the slot-shaped outlet opening in the direction towards the high-pressure nozzle being arranged offset to the longitudinal axis of the second through-channel.

18. The nozzle arrangement according to claim 1, wherein the nozzle outlet part has at least two low-pressure nozzles arranged symmetrically to the high-pressure nozzle.

19. The nozzle arrangement according to claim 1, wherein the nozzle inlet part has a cutout into which the inlet duct opens and in which the nozzle outlet part is displaceably held.

20. The nozzle arrangement according to claim 19, wherein the nozzle outlet part is held in the cutout in rotation-resistant manner.

21. The nozzle arrangement according to claim 20, wherein the nozzle arrangement has a rotary part which is mounted rotatably and axially displaceably on the nozzle inlet part via a thread and which has an entraining element for displacing the nozzle outlet part.

22. The nozzle arrangement according to claim 21, wherein the nozzle arrangement has two housing half-shells which are connected in rotation-resistant manner to the rotary part.
